(19) United States
(12) Patent Application Publication
(10) Pub. No.: US 2021/0200343 A1
(43) Pub. Date: Jul. 1, 2021

(54) DIGITAL PENS FOR COMPUTING DEVICES

(71) Applicant: HEWLETT-PACKARD DEVELOPMENT COMPANY, L.P., Houston, TX (US)

(72) Inventors: Charles J. STANCIL, Houston, TX (US); Derek KANAS, Houston, TX (US)

(73) Assignee: HEWLETT-PACKARD DEVELOPMENT COMPANY, L.P., Houston, TX (US)

(21) Appl. No.: 16/084,069

(22) PCT Filed: Jun. 30, 2017
(86) PCT No.: PCT/US2017/040333

§ 371 Date: Sep. 11, 2018

(51) Int. Cl. G06F 3/0354; G06F 3/038

(52) U.S. Cl. CPC G06F 3/03545; G06F 3/038

(57) ABSTRACT

Examples disclosed herein provide a digital pen for a computing device. As an example, the digital pen includes a barrel and an assembly coupled to the barrel. The assembly includes a tip along a first end of the assembly, a structure along a second end of the assembly opposite from the first end, and a shaft coupling the tip and the structure to each other. The shaft is disposed in an opening of the assembly, the opening including a pivot point to transfer a force to be applied at the tip to a reactionary force at the structure. The digital pen includes material with an array of force sensors that the structure is to move along. Based on a location of force sensors from the array that is to receive the reactionary force from the structure, a tilt angle is determined.

### BACKGROUND

The emergence and popularity of mobile computing has made portable computing devices, due to their compact design and light weight, a staple in today's marketplace. Computing devices, such as notebook computers and tablet computers, generally include a display member that is utilized to provide a viewable display to a user. The viewable display may be a touchscreen, allowing the user to interact directly with what is displayed by touching the screen with simple or multi-touch gestures. As an example, an input device, such as a digital pen, may be used with the computing device, to capture handwriting or brush strokes of a user. The computing device may convert handwritten analog information, provided by the digital pen, into digital data, enabling the data to be utilized in various applications on the computing device.

### BRIEF DESCRIPTION OF THE DRAWINGS

FIGS. 1A-C illustrate components of a digital pen for a computing device, including pressure-sensing material, according to an example;

FIGS. 2A-B illustrate the digital pen used perpendicular to a surface, according to an example;

FIGS. 3A-B illustrate the digital pen used at an angle with respect to the surface, according to an example;

FIGS. 4A-B illustrate the digital pen used at another angle with respect to the surface, according to an example;

FIG. 5 illustrates internal components of a digital pen, according to an example.

### DETAILED DESCRIPTION

Examples disclosed herein provide a digital pen with pressure-sensing material that is used to determine when a user is likely using the digital pen with a computing device and/or a tilt angle of the digital pen with respect to the computing device. As will be further described, the pressure-sensing material may include an array of force sensors, or a contiguous surface of such sensors, that provides a high degree of granularity for determining when the digital pen is being used and its tilt angle. The high degree of granularity provided by the pressure-sensing material may allow for usage of the digital pen to be detected even when a low pressure is applied at the tip of the digital pen (e.g., less than 1 gram). As the pressure-sensing material may be used as a single sensor subsystem for detecting both pressure and tilt, cost of manufacturing may be lowered since separate sensors are not required for detecting pressure and tilt. In addition, the pressure-sensing material may provide flexibility in the design and materials used in the body of the digital pen.

As an example, the user is likely using the digital pen when a sufficient force is applied at a tip of the digital pen that, as will be further described, is then translated to the pressure-sensing material via an assembly of the digital pen. By using the pressure-sensing material, the initial starting pressure required to be applied at the tip for detecting when the user is writing may be low, as described above. In addition to detecting the pressure applied at the tip, the pressure-sensing material may be use for tilt detection. For example, upon using the pressure-sensing material to detect the tilt angle, or incident angle of the digital pen upon a touch-sensitive surface of the computing device, the digital pen can be used for artistic effect on the touch-sensitive surface, or for power management, as examples. With regards to artistic effect, the tilt angle may be used to emulate the width of a brush. In addition to modifying input provided by the digital pen, the tilt angle may be used for power management purposes. For example, if the tilt angle is below a threshold amount, suggesting that the digital pen may be lying flat on the touch sensitive surface of the computing device, the touchscreen of the computing device may revert to a touch mode, and not an active pen mode, thereby conserving power. In addition to the computing device conserving power, the digital pen may also conserve power by turning off a transmitter of the digital pen when the tilt angle between the digital pen and the writing surface of the computing device is below a threshold amount.

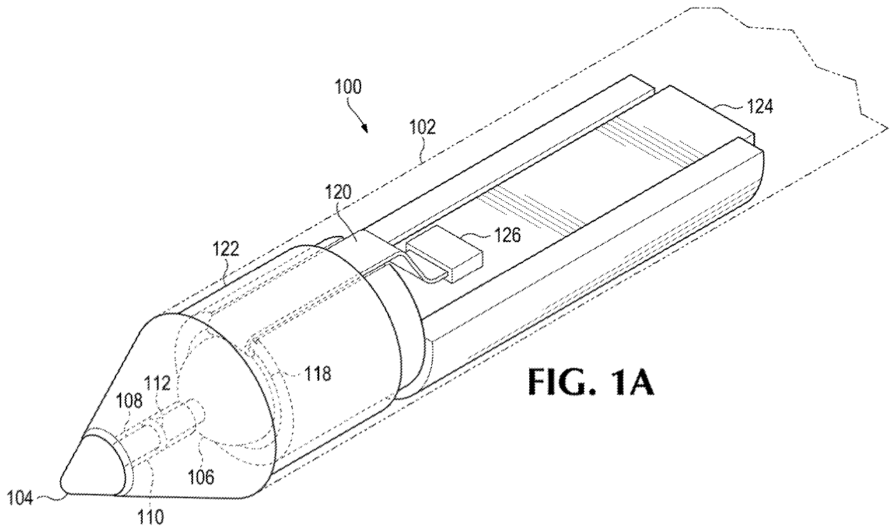

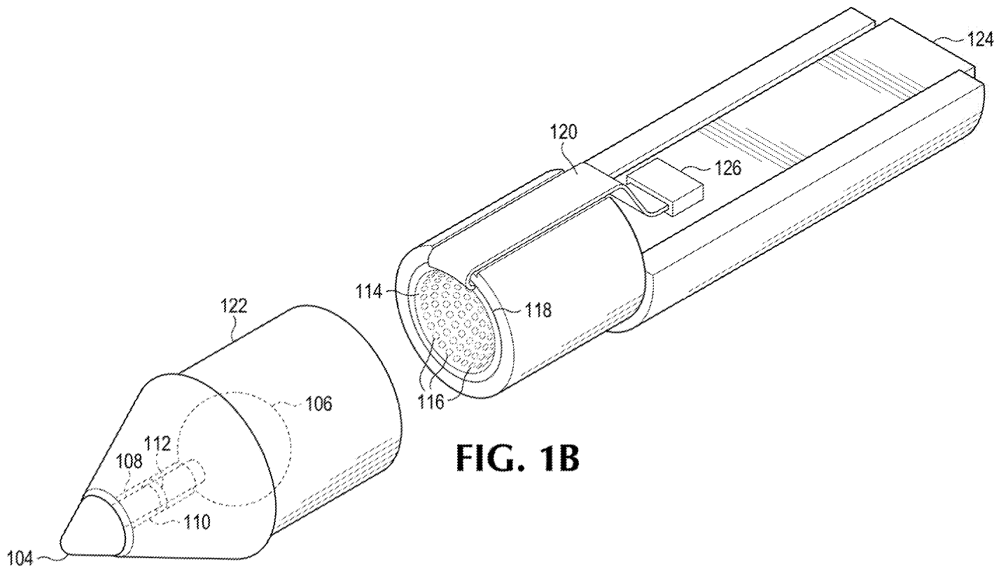

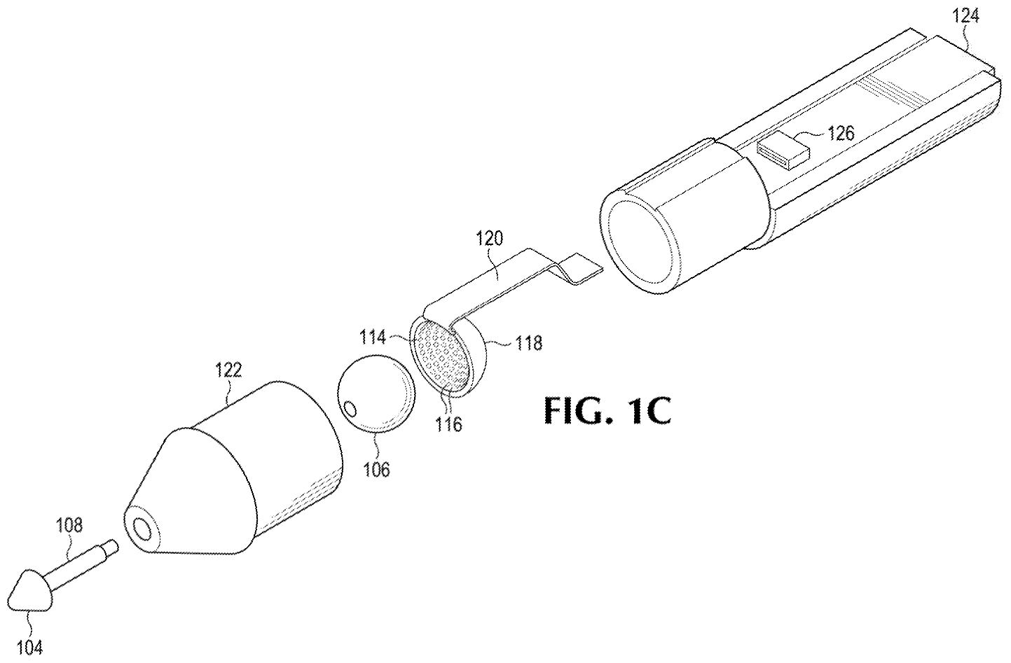

With reference to the figures, FIGS. 1A-C illustrate components of a digital pen 100 for a computing device, including pressure-sensing material 114 that may be used for determining usage of the digital pen 100 and/or a tilt angle of the digital pen 100 with respect to the computing device, according to an example. Referring to FIG. 1A, the digital pen 100 includes a barrel 102 for housing the components of the digital pen 100, and an assembly that may be coupled to the barrel 102 along a writing end of the digital pen 100. As will be further described, the assembly includes a nib/tip/shaft structure that moves along the pressure-sensing material 114 for determining usage of the digital pen 100 and a tilt angle of the digital pen 100 with respect to the computing device. For example, the assembly includes a tip 104 along a first end of the assembly, and a structure 106 along a second end of the assembly opposite from the first end. A shaft 108 couples the tip 104 and the structure 106 to each other, and is disposed in an opening 110 of the assembly.

The structure including the tip 104, shaft 108, and structure 106 may be a single part or separated into multiple parts. For example, referring to FIG. 1C, the structure is separated into two parts, so that it can be assembled into the pen at 122. The first part may include the tip 104 and shaft 108, and the second part may include the structure 106 that the shaft 108 then inserts into, for example, with an interference fit. Referring back to FIG. 1A, the opening 110 of the assembly includes a pivot point 112 for transferring or translating a force to be applied at the tip 104 to a reactionary force at the structure 106. As will be further described, the pivot point 112 may be used in combination with the pressure-sensing material 114 to determine the tilt angle of the digital pen 100 with respect to the computing device.

Referring to FIG. 18, removing the assembly from the digital pen 100 exposes the pressure-sensing material 114 that the structure 106 is to move along for determining pressure applied at the tip 104 and a tilt angle of the digital pen 100 with respect to the computing device. As an example, the pressure-sensing material 114 includes an array of force sensors 116, where each force sensor 116 has the capability to independently detect a pressure or force applied to it, similar to the Pressure Grid™ technology provided by Sensel®. The force sensors 116 may have a high degree of sensitivity and a high dynamic range, where the array of force sensors 116 may be able to detect anything from a feather-light tap to a hard push.

The density of the force sensors 116 may vary as well, where a greater amount of force sensors 116 across the pressure-sensing material 114 may provide a higher degree of accuracy when determining the pressure and tilt angle of the digital pen 100. For example, one force sensor 116 may be provided every square millimeter, or 500 force sensors 116 every square inch. As will be further described, as the digital pen 100 is tilted with respect to the computing device, a set of force sensors 116 from the array may receiving greater pressure from the structure 106 compared to other force sensors 116 from the array. The location of this set of force sensors 116 along the pressure-sensing material 114 may be used to detect the tilt angle of the digital pen 100 with respect to the computing device. Referring to the figures, the structure 106 may be a ball, and the pressure-sensing material 114 with the array of force sensors 116 may be disposed in a concave socket 118 to accommodate the ball. However, the shape of the structure 106 and corresponding interaction with the pressure-sensing material 114 may vary. For example, the pressure-sensing material 114 can be formed into a 3D shape to accommodate the structure 106 moving along it, according to how a user is writing with the digital pen 100, as will be further described.

As an example, the concave socket 118 may be part of or coupled to a flexible printed circuit (FPC) 120. The FPC 120 may then be connected to a circuit board 124 of the digital pen 100 at 126. Information collected from the pressure-sensing material 114 may be transmitted to the circuit board 124 via the FPC 120. As will be further described, the digital pen 100 may be in wireless communication with the computing device, for example, via a wireless transceiver. The wireless transceiver may then transmit the information collected from the pressure-sensing material 114 to the computing device. For example, an application running on the computing device may determine whether the artistic effect described above should be applied, based on the tilt angle of the digital pen 100 with respect to the computing device.

Referring to the following figures, while the digital pen 100 is being used with a computing device, a location of the force sensors 116 from the array that is to receive the greatest pressure or force from the structure 106 may be used to determine the tilt angle of the digital pen 100 with respect to the computing device. With the number of force sensors 116 provided on the pressure-sensing material 114, the pressure-sensing material 114 can sense many points in an XY field. As described above, each point, or force sensor 116, can sense pressure, and based on the location of the point receiving the greatest pressure, the pressure-sensing material 114 will know where the highest pressure is occurring. As an example, the following formula may be used to determine the tilt angle:

$$Tilt angle = \frac{360 \times L}{2 \times π \times r}$$

where r is the radius of the structure 106 and L is the radial distance between a center point of the socket 118, where the pressure-sensing material 114 is disposed, and the location of the force sensors 116 in the socket 118 that is receiving the greatest pressure or force from the structure 106. As mentioned above, the pivot point 112 may transfer or translate the force to be applied at the tip 104 to a reactionary force at the structure 106 to be applied to the pressure-sensing material 114. As the location of the force sensors 116 from the array that is to receive the reactionary force is to change, the tilt angle of the digital pen 100 with respect to the computing device is to change as well. As will be further described, while force is to be applied at the tip 104, the pivot point 112 is to cause the structure 106 to move along the pressure-sensing material 114 according to a tilt of the digital pen 100 with respect to the computing device.

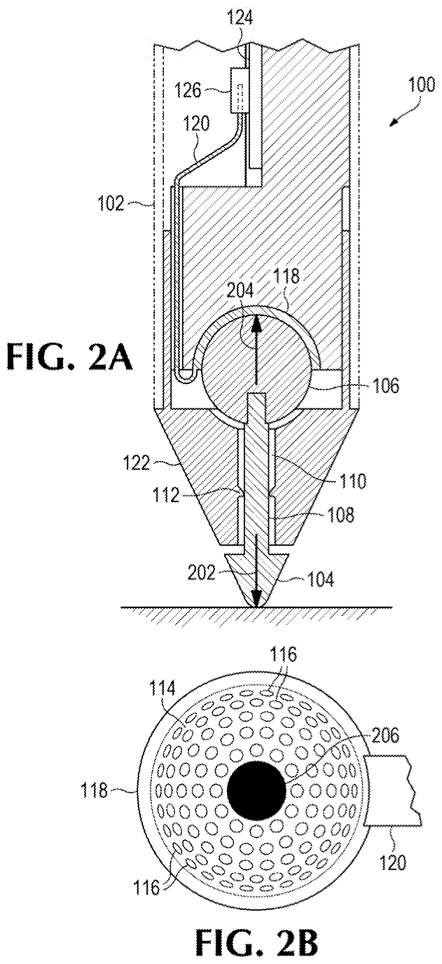

Referring to FIGS. 2A-8, the digital pen 100 is being used perpendicular to a surface, such as the touchscreen surface of the computing device, according to an example. As illustrated in FIG. 2A, a force 202 is applied at the tip 104. As the force 202 is being applied perpendicular to the surface, the structure 106 may apply a correspondingly equal force 204 to the pressure-sensing material 114 in the socket 118. Referring to FIG. 28, a set 206 of force sensors 116 that is to receive the force 204 may be found in the center point of the socket 118, due to the perpendicular orientation of the digital pen 100 with respect to the computing device, as illustrated in FIG. 2A. As a result, the tilt angle, or writing angle, of the digital pen 100 may be 0 degrees. The set 206 of force sensors 116 may correspond to one force sensor 116 or a cluster of force sensors 116 around the center point of the socket 118.

In addition to determining the tilt angle, the pressure-sensing material 114 may determine when the user is likely intending to write with the digital pen. As mentioned above, the force sensors 116 may have a high degree of sensitivity and a high dynamic range, where the array of force sensors 116 may be able to detect anything from a feather-light tap to a hard push. As a result, the sensitivity of the digital pen 100 for determining when the user is intending to write may be controlled by implementing a threshold. For example, when the reactionary force 204 the structure 106 is to apply on the pressure-sensing material 114 is above the threshold value, the digital pen 100 may enter a writing mode. In addition, the pressure-sensing material 114 may detect how hard the user is writing with the digital pen 100 according to a magnitude of the reactionary force 204 the force sensors 116 from the array is to receive from the structure 106.

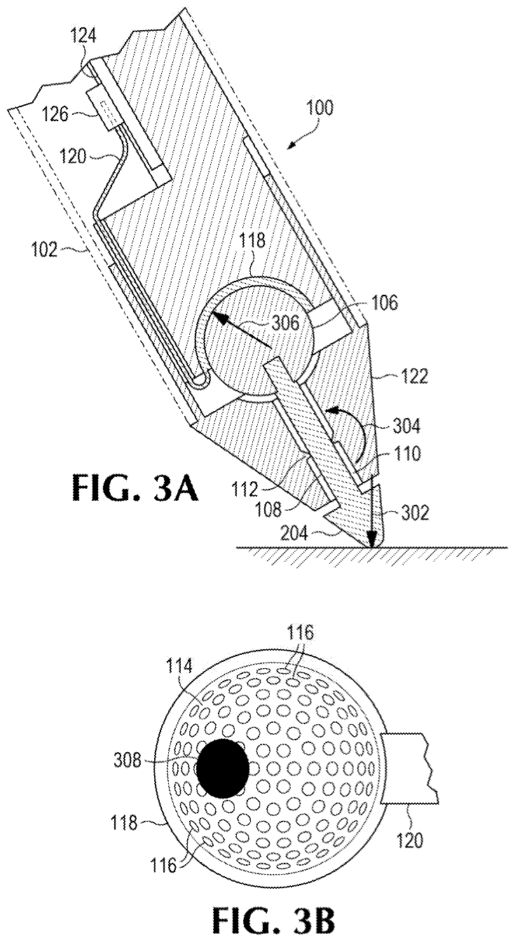

Referring to FIGS. 3A-B the digital pen 100 is being used at an angle with respect to the touchscreen surface of the computing device, according to an example. As illustrated in FIG. 3A, a force 302 is applied at the tip 104. Illustrated by arrow 304, the pivot point 112 may transfer or translate the force 302 applied at the tip 104 to a reactionary force 306 the structure 106 is to apply to the pressure-sensing material 114 disposed in the socket 118. As an example, while the force 302 is applied at the tip 104, the pivot point 112 is to cause the structure 106 to move along the pressure-sensing material 114 according to a tilt of the digital pen 100. Referring to FIG. 38, a set 308 of force sensors 116 receives the force 306 from the structure 106. The set 308 of force sensors 116 may correspond to one force sensor 116 or a cluster of force sensors 116, according to the density of force sensors 116 provided on the pressure-sensing material 114. As an example, based on the radial distance between the center point of the socket 118 and the set 308 of force sensors 116, the tilt angle of the digital pen 100 may be 30 degrees.

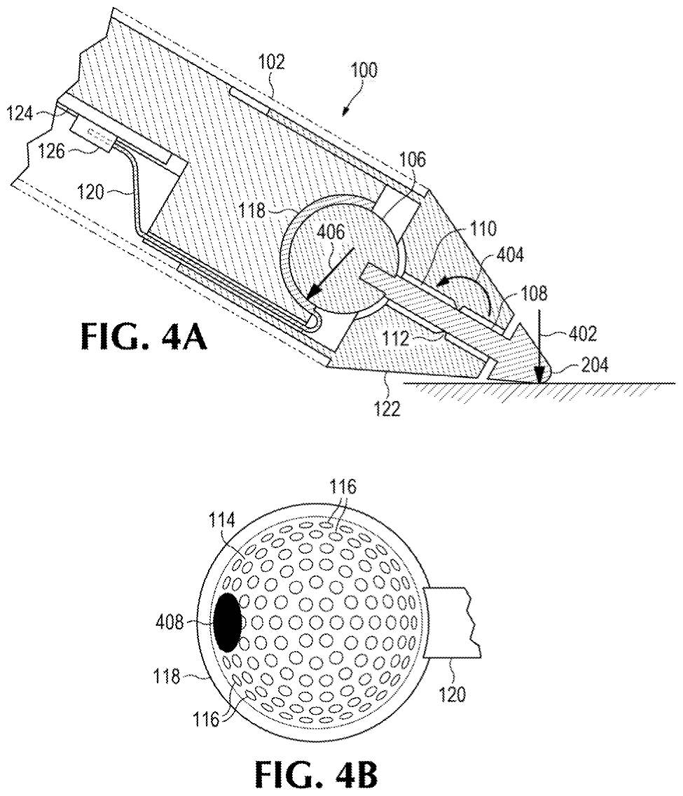

Referring to FIGS. 4A-8, the digital pen 100 is being used at another angle with respect to the touchscreen surface of the computing device, according to an example. As illustrated in FIG. 4A, a force 402 is applied at the tip 104. Illustrated by arrow 404, the pivot point 112 may transfer or translate the force 402 applied at the tip 104 to a reactionary force 406 the structure 106 is to apply to the pressure-sensing material 114 disposed in the socket 118. As an example, while the force 402 is applied at the tip 104, the pivot point 112 is to cause the structure 106 to move along the pressure-sensing material 114 according to a tilt of the digital pen 100. Referring to FIG. 4B, a set 408 of force sensors 116 receives the force 406 from the structure 106. Comparing set 408 in FIG. 4B to set 308 FIG. 3B, the structure 106 applies greater pressure to force sensors 116 closer to the end of the socket 118 as the tilt angle of the digital pen 100 increases. The set 408 of force sensors 116 may correspond to one force sensor 116 or a cluster of force sensors 116, according to the density of force sensors 116 provided on the pressure-sensing material 114. As an example, based on the radial distance between the center point of the socket 118 and the set 408 of force sensors 116, the tilt angle of the digital pen 100 may be 60 degrees.

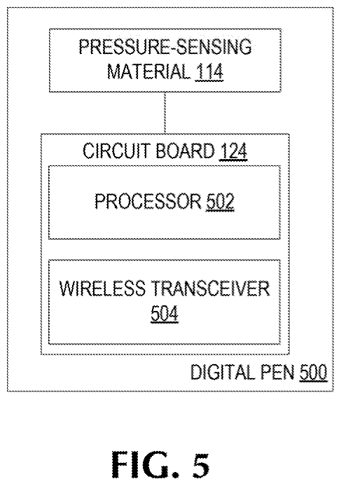

FIG. 5 illustrates internal components of a digital pen 500, according to an example. Elements in FIG. 5 may share the reference numeral of similar elements of digital pen 100. As an example, internal components of the digital pen 300 may be used for detecting when a user is intending to write with the digital pen 500, for example, based on the amount of pressure applied at the tip, and a tilt angle of the digital pen 500 with respect to a touchscreen surface of the computing device. As described above, the pressure-sensing material 114 may be used for detecting the pressure applied and the tilt angle. Based on information collected by the pressure-sensing material 114, a switch on a circuit board 124 may be triggered to activate elements of the circuit board 124, such as a wireless transceiver 504 for establishing wireless communication between the digital pen 500 and computing device.

As used herein, a circuit board refers to a board that mechanically supports and electrically connects electronic components using conductive tracks, pads and/or other features. For instance, circuit board 124 may include copper tracks and conductive surfaces attached to a substrate. Various electrical components, such as capacitors and resistors, may be soldered to circuit board 124. As mentioned, circuit board 124 may be used to activate and deactivate elements of the circuit board 124, such as the wireless transceiver 504. As shown in FIG. 5, wireless transceiver 504 may be coupled to circuit board 124. In some examples, circuit board 124 may control wireless transceiver 504. Said differently, wireless transceiver 504 may be activated via a switch on the circuit board 124. As an example, with regards to the power management features described above, the switch on the circuit board 124 may activate or deactivate the wireless transceiver 504 based on the reactionary force that the structure 106 applies to the pressure-sensing material 114. If the reactionary force is above a threshold value, the wireless transceiver 504 may be activated in order to establish wireless communications between the digital pen 500 and computing device. However, if the reactionary force is below the threshold value, the wireless transceiver 504 may be deactivated, in order for the digital pen 500 to conserve power.

Digital pen 500 may further include a processor 502. Processor 502 may be a hardware processor such as a central processing unit (CPU), a semiconductor based microprocessor, and/or other hardware devices suitable for retrieval, reception, and/or execution of instructions. In some examples, processor 502 may be coupled to circuit board 124. In such examples, processor 502 may be activated upon activation of circuit board 124. As an example, upon the pressure-sensing material 114 detecting a tilt angle of the digital pen 500 with respect to the computing device, as described above, the processor 502 may wirelessly transmit this information to the computing device, where an application running on the computing device may determine whether any artistic effect should be applied to the input the user is providing via the digital pen 500 on the touchscreen surface of the computing device. For example, if the digital pen 500 is being used as a pencil, if the tilt angle of the digital pen 500 with respect to the computing device exceeds a threshold, the input may be processed differently (e.g., entered as sketching input).

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A digital pen for a computing device, the digital pen comprising:
a barrel;
an assembly coupled to the barrel along a writing end of the digital pen, the assembly comprising:
a tip along a first end of the assembly;
a structure along a second end of the assembly opposite from the first end; and
a shaft coupling the tip and the structure to each other, the shaft disposed in an opening of the assembly, wherein the opening comprises a pivot point to transfer a force to be applied at the tip to a reactionary force at the structure; and
material with an array of force sensors that the structure is to move along, wherein the material is to detect a tilt angle of the digital pen with respect to the computing device, based on a location of force sensors from the array that is to receive the reactionary force from the structure.

2. The digital pen of claim 1, wherein the force sensors from the array that is to receive the reactionary force from the structure, is to receive greater pressure from the structure compared to other force sensors from the array.

3. The digital pen of claim 1, wherein while the force is to be applied at the tip, the pivot point is to cause the structure to move along the material according to a tilt of the digital pen.

4. The digital pen of claim 1, wherein the structure is a ball and the material with the array of force sensors is disposed in a concave socket to accommodate the ball.

5. The digital pen of claim 4, wherein as the location of the force sensors from the array that is to receive the reactionary force is to change, the tilt angle of the digital pen with respect to the computing device is to change.

6. The digital pen of claim 1, wherein the material is to detect the force to be applied at the tip, according to the reactionary force the structure is to apply on the material.

7. The digital pen of claim 6, wherein the material is to detect how hard a user is writing with the digital pen according to a magnitude of the reactionary force the force sensors from the array is to receive the from the structure.

8. A digital pen for a computing device, the digital pen comprising:
a barrel;
an assembly coupled to the barrel along a writing end of the digital pen, the assembly comprising:
a tip along a first end of the assembly;
a structure along a second end of the assembly opposite from the first end; and
a shaft coupling the tip and the structure to each other, the shaft disposed in an opening of the assembly, wherein the opening comprises a pivot point to transfer a force to be applied at the tip to a reactionary force at the structure;
material with an array of force sensors that the structure is to move along, wherein the material is to detect the force to be applied at the tip, according to the reactionary force the structure is to apply on the material;
a circuit board disposed within the digital pen, wherein the circuit board is to activate a wireless transceiver when the reactionary force the structure is to apply on the material is above a threshold value; and
a processor to wirelessly transmit information collected by the material to the computing device.

9. The digital pen of claim 8, wherein the material is to detect how hard a user is writing with the digital pen according to a magnitude of the reactionary force the force sensors from the array is to receive the from the structure.

10. The digital pen of claim 8, wherein the material is to detect a tilt angle of the digital pen with respect to the computing device, based on a location of force sensors from the array that is to receive the reactionary force from the structure.

11. The digital pen of claim 10, wherein the force sensors from the array that is to receive the reactionary force from the structure, is to receive greater pressure from the structure compared to other force sensors from the array.

12. The digital pen of claim 8, wherein while the force is to be applied at the tip, the pivot point is to cause the structure to move along the material according to a tilt of the digital pen.

13. A digital pen for a computing device, the digital pen comprising:
a barrel;
an assembly coupled to the barrel along a writing end of the digital pen, the assembly comprising:
a tip along a first end of the assembly;
a structure along a second end of the assembly opposite from the first end; and
a shaft coupling the tip and the structure to each other, the shaft disposed in an opening of the assembly, wherein the opening comprises a pivot point to transfer a force to be applied at the tip to a reactionary force at the structure; and
material with an array of force sensors that the structure is to move along, wherein the material is to detect the force to be applied at the tip and a tilt angle of the digital pen with respect to the computing device.

14. The digital pen of claim 13, wherein the material is to detect the tilt angle based on a location of force sensors from the array that is to receive the reactionary force from the structure.

15. The digital pen of claim 14, wherein the force sensors from the array that is to receive the reactionary force from the structure, is to receive greater pressure from the structure compared to other force sensors from the array.
